(19) United States
(12) Patent Application Publication
(10) Pub. No.: US 2015/0016696 A1
(43) Pub. Date: Jan. 15, 2015

(54) USER AUTHENTICATION METHOD AND DEVICE

(71) Applicant: MORPHO, Issy Les Moulineaux (FR)

(72) Inventors: Sylvaine PICARD, Issy Les Moulineaux (FR); William KETCHANTANG, Issy Les Moulineaux (FR)

(21) Appl. No.: 14/331,532

(22) Filed: Jul. 15, 2014

(30) Foreign Application Priority Data
Jul. 15, 2013 (FR) 1356928

(51) Int. Cl. G06K 9/00; G06T 7/00

(52) U.S. Cl. CPC G06K 9/00087; G06T 7/0014
USPC 382/124

(57) ABSTRACT

A method for checking the genuineness of a finger includes: a capture step during which a capture device captures a full field OCT image of the face of the finger; a co-occurrence matrix computing step during which a processing unit computes the co-occurrence matrix of the image thus captured; an entropy computing step during which the processing unit computes the entropy of the co-occurrence matrix thus computed; a contrast computing step during which the processing unit computes the contrast of the co-occurrence matrix thus computed; a mean computing step during which the processing unit computes the mean of the image thus captured; a comparison step during which the processing unit compares the characteristics thus computed with reference values of these characteristics; and a decision-taking step during which the processing unit takes a decision concerning the authenticity of the finger or palm from the result of the comparison step.

The present invention concerns a method for checking the authenticity of a finger or palm, as well as a checking device suitable for implementing such a checking method.

It finds an application in the field of biometric recognition and in particular in the field of identification by analysing fingerprints, the palm, or a venous network.

In the context of an identification/authentification of a person by analysing his biometrics (fingerprint, vein, palm), it is preferable to check that the element bearing the print is a real finger rather than a decoy presented for the purpose of deceiving the identification/authentification system.

There exist numerous solutions for checking that the element bearing the print is indeed a finger. Software solutions can be cited such as those presented in the document entitled “Wavelet based fingerprint liveness detection” by Y. S. Moon et al (Electron. Lett. Vol 41, No. 20, pp 1112-1113, 2005). Hardware solutions can also be cited, based on physical characteristics of the finger, such as for example oximetry, temperature, etc.

These solutions give good results in the majority of cases of fraud, but decoys are becoming more and more sophisticated and, in some cases, these new decoys manage to deceive these checking systems.

One object of the present invention is to propose a method for checking the authenticity of a finger or palm that does not have the drawbacks of the prior art and which in particular provides better detection of a decoy.

To this end, a method is proposed for checking the authenticity of a finger or palm by means of a checking device comprising a device for capture by full field optical coherence tomography (FF OCT) designed to capture at least one image of a plane parallel to the face of the finger or palm and a processing unit, the method comprising:
a capture step during which the capture device captures a full field OCT image of the finger or palm,
a co-occurrence matrix computing step during which the processing unit computes the co-occurrence matrix of the image thus captured,
an entropy computing step during which the processing unit computes the entropy of the co-occurrence matrix thus computed,
a contrast computing step during which the processing unit computes the contrast of the co-occurrence matrix thus computed,
a mean computing step during which the processing unit computes the mean of the image thus captured,
a comparison step during which the processing unit compares the characteristics thus computed with reference values of these characteristics, and
a decision-taking step during which the processing unit takes a decision concerning the authenticity of the finger or palm from the result of the comparison step.

Advantageously, the checking method further comprises at least one of the following steps preceding the comparison and decision steps:
a surface density computing step during which the processing unit performs, on the captured image, a segmentation of the peaks of the skin and pores and computes the surface density of the peaks of the skin and pores of the captured image,
a ratio computing step during which the processing unit computes the ratio between the degree of flattening and the degree of asymmetry of the distribution of grey levels of the captured image,
a step of computing the density of the saturated pixels.

Advantageously, the checking method comprises, between the capture step and the co-occurrence computing step, a Gaussian smoothing step implemented by the processing unit and during which the captured image undergoes Gaussian smoothing, and in that the co-occurrence computing step, the entropy computing step, the contrast computing step, the mean computing step, the optional surface density computing step, the optional ratio computing step and the optional step of computing the density of the saturated pixels are performed on the image thus smoothed.

Advantageously, the method comprises a variance computing step during which the processing unit computes the variance of the image thus captured or smoothed.

Advantageously, the checking method comprises, subsequently to the capture step, a step of comparing the captured image with reference images in a database and the decision taking step takes into account the result of this comparison step in order to decide on the authenticity of the finger or palm and the identity of the bearer of the finger or palm.

Advantageously, the capture step consists of:
a capture of at least two full field OCT images of the finger or palm by the capture device,
a measurement of movement between said images with respect to each other,
a readjustment of said images with respect to each other if the movement measurement detects a movement,
generation of a new image by computing the mean of said images.

The invention also proposes a device for checking the authenticity of a finger or palm, the checking device being intended to implement the checking method according to one of the above variants and comprising:
a transparent sheet on which the finger or palm comes to bear,
a capture device designed to capture a full field OCT image of a plane parallel to the face of the finger or palm through the transparent sheet,
a processing unit comprising:
   co-occurrence matrix computing means designed to compute the co-occurrence matrix of the captured image,
   entropy computing means designed to compute the entropy of the co-occurrence matrix,
   contrast computing means designed to compute the contrast of the co-occurrence matrix,
   mean computing means designed to compute the mean of the captured image,
   comparison means designed to compare the computed characteristics with reference values of these characteristics, and
   decision-taking means designed to take a decision concerning the authenticity of the finger or palm (50) from the result supplied by the comparison means.

Advantageously, the processing unit further comprises:
surface density computing means designed to effect, on the captured image, a segmentation of the peaks of the skin and pores and to compute the surface density of the peaks of the skin and pores of the captured image, and/or
ratio computing means designed to compute the ratio between the degree of flattening and the degree of asymmetry of the distribution of grey levels of the captured image, and/or
means for computing the density of the saturated pixels.

Advantageously, the processing unit further comprises Gaussian smoothing means designed to subject the captured image to Gaussian smoothing, and the co-occurrence computing means, the entropy computing means, the contrast computing means, the mean computing means, the optional surface density computing means, the optional ratio computing means and the optional means for computing the density of the saturated pixels are designed to process the image smoothed by the Gaussian smoothing means.

Advantageously, the processing unit comprises variance computing means designed to compute the variance of the captured or smoothed image.

Advantageously, the capture device is designed to capture at least two full field OCT images, the processing unit comprises means for measuring movement between said images with respect to each other, means for readjusting said images with respect to each other and means for generating a new image by computing the mean of said images.

Advantageously, the transverse resolution is 0.8 to 5 microns.

Advantageously, the image capture depth is between 10 μm and 100 μm.

Advantageously, the processing unit then comprises second comparison means designed to compare the captured image with reference images in a database and the decision taking means are designed to also take a decision concerning the identity of the bearer of the finger from the results supplied by the second comparison means.

Advantageously, the capture device comprises an oscillating mirror and a photodetector designed to acquire at least two images showing the oscillation of the mirror, the processing unit comprises comparison means designed to compare said images with each other and to determine the existence of a movement of the finger or palm between each image, readjustment means designed to readjust the images with respect to each other and computing means designed to compute the component modulated by the movement of the mirror of said images.

The features of the invention mentioned above, as well as others, will emerge more clearly from a reading of the following description of an example embodiment, said description being given in relation to the accompanying drawings, among which:

FIG. 1 depicts a device for checking the authenticity of a finger or palm according to the invention,

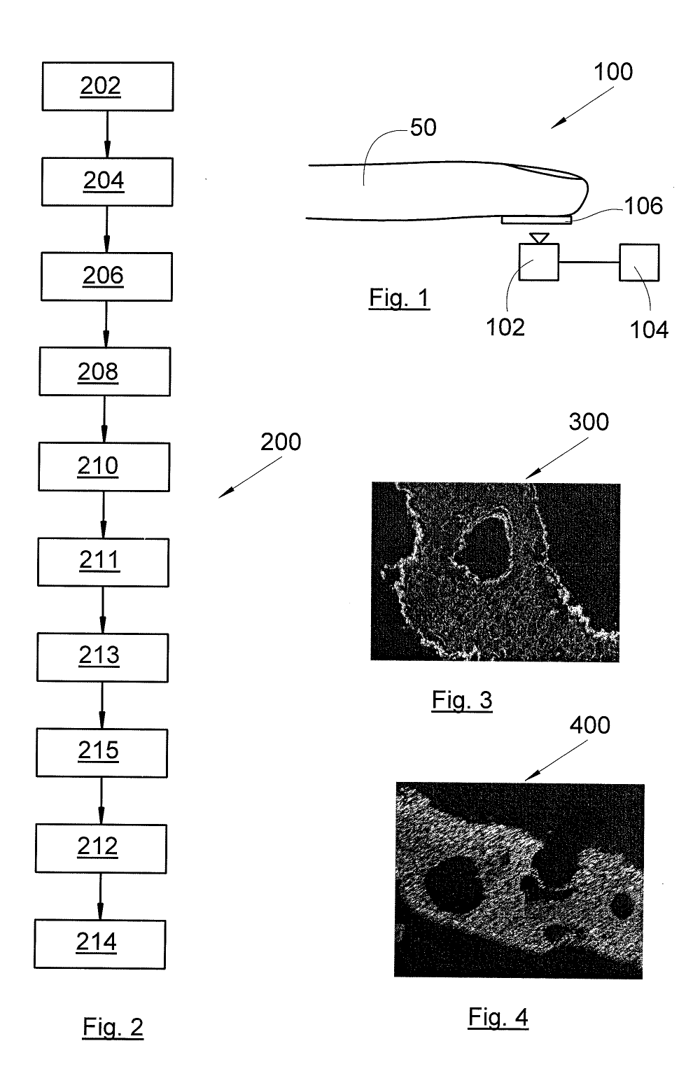

FIG. 2 depicts an algorithm of a method for checking the authenticity of a finger according to the invention,

FIG. 3 shows an image of a true finger,

FIG. 4 shows an image of a false finger for a particular example of fraud, and

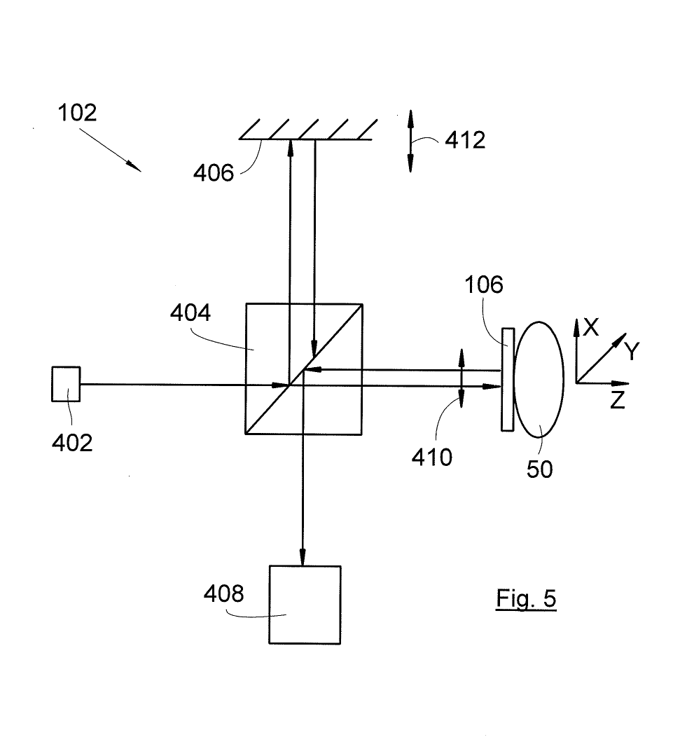

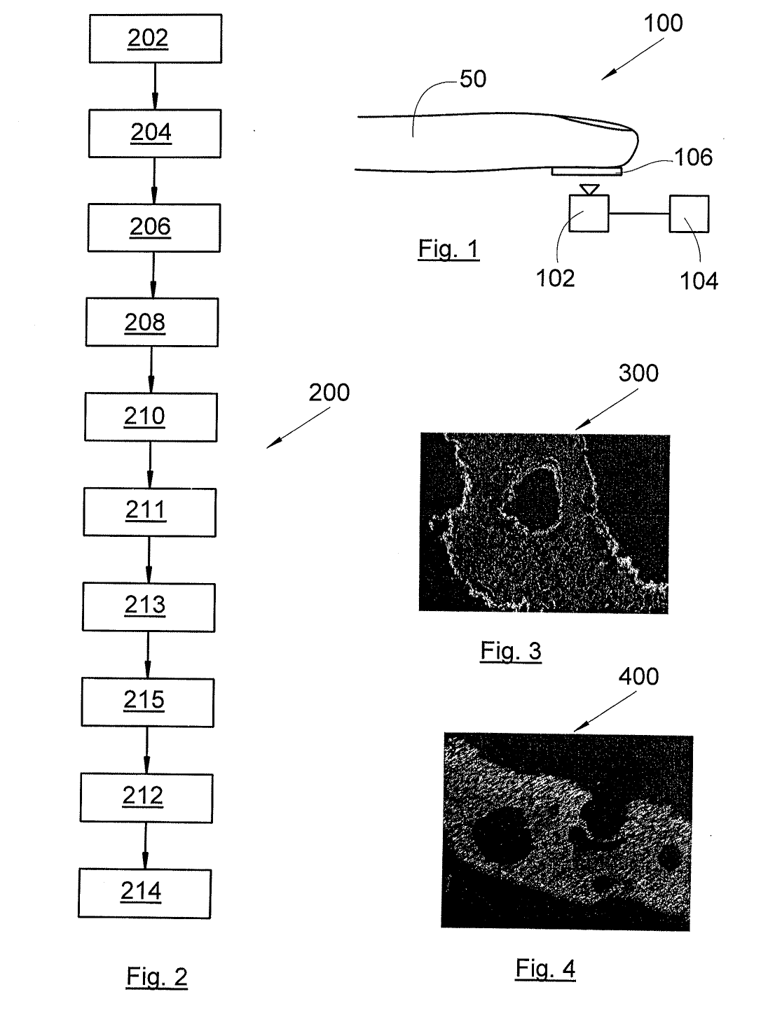

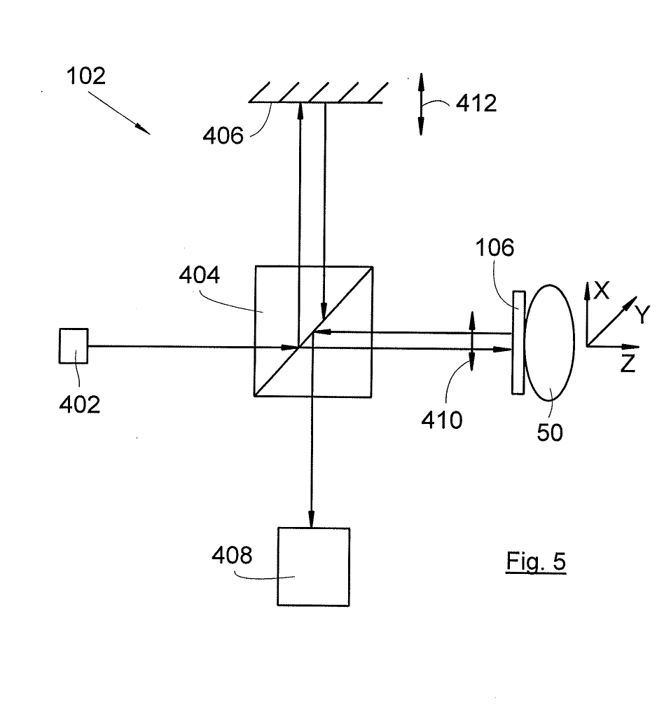

FIG. 5 shows an optical coherence tomography capture device used in the context of the invention.

FIG. 1 shows a checking device 100 intended to check whether the finger 50 is a real finger or not.

The checking device 100 comprises a transparent sheet 106 on which the finger 50 comes to bear so as to remain stable, a capture device 102 intended to capture an image of the finger 50 through the transparent sheet 106, and a processing unit 104.

The capture device 102 comprises means necessary for capturing an image of the finger 50.

In particular, the capture device 102 comprises at least one capture means such as a camera.

The capture device 102 is a full field optical coherence tomography (FF OCT) capture device designed to take an image of a plane parallel to the sheet 106, an embodiment of which is shown in FIG. 5.

The three-dimensional scan of an object obtained by the OCT technique has the drawback of requiring an excessively long acquisition time compared with the movements, even perceptible, of the object the image of which is acquired (such as the acquired image of a finger, a palm or a venous network). This is because the acquisition of the image may be significantly interfered with in the case where the finger moves even slightly during this acquisition.

Advantageously, the full field OCT or FF OCT technology used according to the invention advantageously makes it possible to acquire the highly resolve image of the object in a sufficiently short time not to be interfered with by the slight movements of the finger. This is because full field OCT or FF OCT technology consists of acquiring a single series of images “en-face” or on a single plane at very high resolution (less than 5 micrometers) when the OCT technology commonly used aims at acquiring several series of images of lower resolution on several planes.

Such an arrangement affords a very great advantage in terms of ergonomics since the image acquisition is rapid and robust with a very slight movement of the finger.

In the case where it is sought to effect a recognition of the venous network of the finger or palm, a contactless variant of full field OCT will be used. This is in order to allow the acquisition of the information from the venous network and the full field OCT simultaneously.

The depth at which the tomographic reading is made is less than 100 μm, although different depths can give comparable results in terms of performance. The captured images are images having resolutions of less than 5 μm, and use of the full field OCT capture device 102 makes it possible to capture the structures of skin cells, and even subcutaneous cells, and it is the texture of these structures with high spatial frequencies that are studied and characterised in order to validate the finger 50.

In the case of a full field OCT capture device, the capture means is a photodetector. In the particular case of full field OCT, it will be in the form of a camera.

In particular, the use of a full field OCT capture device makes it possible to obtain an image of the inside of the finger 50 in which the cells are imaged in cross section and therefore to improve the reliability of the check carried out by the checking device 100 since the internal structure of a finger is different from the internal structure of a decoy, which is not living and does not have cells.

FIG. 5 shows an example of a full field OCT capture device 102 that is placed on a Michelson interferometer and which comprises here:
a light source 402,
a beam splitter 404 with a splitter blade,
a reference mirror 406, and
a photodetector 408.

The double arrow 410 represents the transverse scan direction parallel to the axis x.

The double arrow 412 represents the axial scan direction in depth parallel to the axis z.

The light source 402 has a short coherence length given by the formula:

$${L}_{c} = \frac{2 \cdot l n ( 2 )}{π} * \frac{{λ}_{c}^{2}}{Δ λ} ,$$

where λ_{c} is the centre wavelength of the light source 402 and Δλ represents the spectral width of the light source 402.

The phenomenon of interference between the light beam coming from the reference mirror 406 and the light beam coming from the finger 50 appears if the difference in optical path of the light is less than L_{c}.

The reference mirror 406 moves so as to allow scanning of the finger 50 along the depth axis z also referred to as scan-A, and a set of scan-As is called scan-B.

The axial resolution (δz on the axis z) is related to L_{c} by the formula

$$δ z = \frac{{L}_{c}}{n}$$

where “n” is the optical refractive index of the finger 50.

Thus, in order to reduce the axial resolution, a light source 402 with a wide band close to wide pass-band Gaussian diffusion is used. For example, with a Ti laser (λ_{c}=810 nm, Δλ=260 nm), the axial resolution is 1.5 microns.

The scan depth is limited by the wavelength penetration and multiple scatterings in the finger 50 and by the numerical aperture (NA) of the optical system that captures the light reflected or diffused by the finger 50. The absorption and the phenomena of diffusion of the light in the finger 50 make the penetration depth fall.

It is necessary to choose the light source 402 so as to allow good characterisation of the internal structure of the finger 50.

The numerical aperture fulfils a role in the field depth of the optical system that captures the light reflected or diffused by the finger 50, and a small numerical aperture is necessary so that the depth of field is high, and therefore a great scan depth. In general, the scan depth in full field OCT is a few millimeters.

The transverse scan, called scan-C, is carried out using the beam illuminating the finger 50, or by moving the finger 50. By means of the transverse scan, the surface of the finger 50 is travelled over. A set of scan-Cs is called scan-T. The transverse resolution (δx,δy) is expressed by

$$δ x = δ y = 0.61 \frac{{λ}_{c}}{NA} .$$

Thus the transverse resolution decreases when NA increases, while the depth of field of the optical system is small and hence a small scan depth.

In general, optical adjustments are performed in order to obtain moderate axial and transverse resolutions approximately equal to 10 microns.

In full field OCT technology, the resolution and depth of penetration in the finger 50 vary respectively from 1 micron to 15 microns and from 1 mm to 3 mm. Thus full field OCT technology is suited to the analysis of tissues of the skin a few millimeters thick. This penetration depth is sufficient to capture full field OCT images revealing the internal structures of the finger 50.

Full field OCT (FF OCT) technology provides a few developments to this arrangement. This is because the photodetector is replaced by a camera, the laser source is replaced by an extended source (such as a filtered halogen lamp or an LED) and two identical lenses are used in the two channels. The mirror must have a surface area greater than the imaged surface area of the finger 50.

By means of FF OCT technology, all the pixels of the capture device 102 simultaneously acquire the light coming from the surface of the illuminated finger. Transverse scanning of the source is no longer necessary for obtaining a two-dimensional image of the finger 50.

The image is then obtained much more quickly and the capture of an image can be limited to the capture of an image at a given depth beyond the sheet 106 against which the finger 50 is held in contact. The movement of the mirror 406 can then be a simple oscillation with an amplitude of less than 1 μm corresponding to the centre wavelength used for the illumination. This arrangement makes it possible no longer to need a great optical depth of field and therefore makes it possible to use lenses with larger numerical apertures and to reduce the transverse resolution below 1 μm.

Such a solution is described in:

the document entitled: “Ultrahigh-resolution full-field optical coherence tomography” by the authors: Arnaud Dubois, Kate Grieve, Gael Moneron, Romain Lecaque, Laurent Vabre and Claude Boccara; and published under the references: APPLIED OPTICS_{—} Vol. 43, No. 14_{—}10 May 2004, p 2874 to 2883, and in

the document entitled: “Large Field, High Resolution Full-Field Optical Coherence Tomography: A Pre-clinical Study of Human Breast Tissue and Cancer Assessment”, by the authors Assayag, O., Antoine, M., Sigal-Zafrani, B., Riben, M., Harms, F., Burcheri, A., Grieve, K., Dalimier, E., Le Conte de Poly, B., Boccara, C.; and published under the references Technol Cancer Res Treat 13, 455-468 (2014) DOI: 10.7785/tcrtexpress.2013.600254.

The duration of acquisition of a full field OCT image can be reduced below 0.1 second.

According to a particular embodiment of the invention, the full field OCT capture device 102 comprises:
a light source of the white halogen lamp type, or of the LED type with a spectral width of between 30 and 250 nm, the coherence length of which is between approximately 1 and 7 microns. The centre wavelength is chosen between green (500 nm) in order to promote resolution to the detriment of the flux reflected by the finger 50 when the image capture depth is small, and near infrared (1 μm) in order to promote depth of penetration and flux to the detriment of resolution.
the axial resolution is around 1 to 7 microns,
the transverse resolution is defined by the performance of the lens and the resolution of the capture device 102, and is from 0.8 to 5 microns, so that the cells of the finger 50 are clearly visible. The axial resolution and the transverse resolution will preferably be chosen of the same order of magnitude,
the image capture depth, referred to as the scan depth, is between 10 μm and 100 μm so as to be less than the depth of the whorls on the finger 50, which makes it possible to capture the form of the whorls, and less than the depth of a fraud implemented in the form of a thin layer,
the acquisition surface area is greater than 1 mm², preferable greater than 15 mm², so as to allow identification of the individual simultaneously,
the oscillations of the reference mirror are produced by micrometric, or piezo, motors, this mirror describing a periodic movement synchronised with the capture device 102 so that the capture device 102 acquires at least 3 images per period. For example, the camera can acquire 4 images per period and the mirror has a surface at least equal to the imaged field,
the capture means is a CCD or CMOS camera that is resolved (more than 1 megapixel) and rapid (more than 60 fps), for example 2048 pixels×2048 pixels and where the number of images per second is 200 fps.

Suitable means can be provided to effect the acquisition of a set of images corresponding to an integer number of oscillation periods of the mirror 406 and then the extraction of the component modulated by the movement of the mirror 406 of this set of images. The acquisition of more than one oscillation period of the mirror 406 makes it possible to reduce the noise by averaging the images with each other. For example, it is possible to acquire 4 images per period during 4 periods, that is to say a total of 16 images.

Advantageously, the extraction of the modulated component of the set of images can be preceded by a step of readjusting the images with respect to each other made possible by the contrast present in the image of the prints. The system will thus be made much less sensitive to small movements of the finger.

Another solution consists of extracting the modulated component for each period of the mirror and then readjusting the images extracted with respect to each other before computing the mean thereof in order to produce the full field OCT image. The capture device 102 then comprises the oscillating mirror 406 and the photodetector 402 designed to acquire at least two images during the oscillation of the mirror 406, and the processing unit 104 then comprises comparison means designed to compare said images with each other and to determine the existence of a movement of the finger or palm 50 between each image, readjustment means designed to readjust the images with respect to each other and computing means designed to compute the component modulated by the movement of the mirror of said images.

The system will preferentially use two identical lenses placed one between the splitter blade and the finger 50 and the other between the splitter blade and the reference mirror 406.

Any other system for implementing full field OCT affording rapid acquisition of an “en-face” image of the finger situated at a chosen depth and with resolutions of between 0.8 and 10 microns in the various axes may suit. This includes in particular FF OCT devices that would use a suitable camera for effecting demodulation at the pixel level, as used for some flight-time cameras (for example those from the company PMDTechnologies GmbH).

If the image field is too small for the application, a system allowing movement of the imaged field will make it possible to acquire several images covering overall an extended field. These images will then be reassembled (stitching or mosaicing) in order to generate a single image taking into account the possibility of a small movement of the finger or palm 50. This system can be implemented by translating part of the device or by adding a movable mirror. The fields will have an overlap and the software, by correlation, will reassemble them coherently.

The speed of the capture device 102 is chosen according to the number of images for each full field OCT acquisition (16 for example) and the time that can be devoted to these acquisitions for ergonomic reasons (for example 0.1 seconds), and the minimum speed is thus around 160 images per second.

If for a transverse resolution of 5 microns and the capture device 102 has 2000 pixels×2000 pixels, the imaged field is then 10×10 mm², which may be sufficient for the application. If the transverse resolution is chosen less than 1 μM (for example 0.8), then the field imaged by the same capture device 102 is reduced to 1.6×1.6 mm, which will in general be insufficient. Recourse is then had to the acquisition of 4×4 images in order to achieve a field of around 6×6 mm².

An image with several depths can be produced. For example, an image at 20 μm, an image at 50 μm and an image at 100 μm under the sheet. This can make it possible to collect more information and to assist in identifying difficult fingers 50.

Fraud can then be detected in an identical fashion on the three images, since the cell structures do not differ significantly for these depths.

If several depths must be acquired, this can be done by a movement of the reference mirror 406 if the depth of field is sufficient, or by a movement of the sheet 106 in contact with the finger 50 with respect to the rest of the device.

FIG. 3 shows an image 300 of a true finger 50 captured by an FF OCT capture device 102 at a depth of 20 microns and on which in particular the boundaries of the finger 50 and an open pore are visible. The boundaries of the finger 50 and the edges of the pore are represented by white lines while the interior remains overall uniform in grey.

FIG. 4 shows an image 400 of an example of fraud where a false finger 50 is produced from white silicone. In this case, there are no true differences between the boundaries and the inside, which remain here both white overall.

From the image captured by the capture device 102, various characteristics relating to the finger 50 are computed and then analysed by the processing unit 104, which makes it possible to deduce from this that the finger 50 is a real finger or a false finger.

The essential characteristics that have been identified are entropy, contrast and mean. The use of these three criteria makes it possible to filter the majority of frauds without making a mistake about real fingers.

In general, the entropy of an image represents the disorder of the visible structure on the image, and the contrast represents the difference in grey level (also referred to as intensity) between a pixel and its neighbours. Entropy and contrast are computed from the co-occurrence matrix with a size of 255×255, for which a computing method is given on the website http://en.wikipedia.org/wiki/Co-occurrence_matrix.

The elements of the co-occurrence matrix are denoted P_{θ}^{T}(i,j) and denote a probability of transition from a grey level i of an original pixel to a grey level j of an adjacent pixel situated at a distance T from the original pixel in the direction θ.

In the context of the invention, the angle θ=0° has been preferred, but other angles such as for example 45°, 90° or 135° may also be used.

In the same way, in the context of the invention, T has been chosen equal to 15, since this gives good results.

The entropy of the co-occurrence matrix is given by the formula:

$$E = - {\sum }_{i , j} {P}_{θ}^{T} ( i , j ) \cdot log ( {P}_{θ}^{T} ( i , j ) ) . \qquad ( 1 )$$

The contrast of the co-occurrence matrix is given by the formula:

$$C = {\sum }_{i , j} {( i - j )}^{2} {P}_{θ}^{T} ( i , j ) . \qquad ( 2 )$$

In formulae (1) and (2) i and j are the indices of the co-occurrence matrix and vary from 0 to 255.

The mean of the image is given by the formula:

$$M = \frac{{\sum }_{k = 1}^{W} {\sum }_{l = 1}^{H} I ( k , l )}{W \cdot H} \qquad ( 3 )$$

where W is the width of the image, H is the height of the image and I(k,l) is the grey level of the pixel of position (k,l).

After calculation of these characteristics, the processing unit 104 compares the values of these characteristics (entropy, contrast, mean) with reference values of these characteristics and, according to these comparisons, the processing unit 104 deduces therefrom that the finger 50 is a real finger or a false finger.

According to a particular embodiment of the invention, a finger 50 is considered to be real when the entropy is between 6.8 and 9, the contrast is between 300 and 680, and the mean is between 60 and 115.

The comparison may be a comparison with a respect to a threshold, that is to say each characteristic is compared with the threshold and, according to its position with respect to the threshold, the processing unit 104 deduces from this that the characteristic represents a real finger or a false finger. Analysis of three characteristics simultaneously ensures good results.

The comparison may be based on other methods such as for example linear discriminant analysis (LNA), the use of support vector machines (SVMs), etc.

FIG. 2 shows an algorithm of a method 200 for checking the validity of a finger 50 implemented by the checking device 100.

The checking method 200 comprises:
a capture step 202 during which the capture device 102 captures a full field OCT image of the finger 50,
a co-occurrence matrix computing step 204 during which the processing unit 104 computes the co-occurrence matrix [P_{θ}^{T}(i,j)] of the image thus captured,
an entropy computing step 206 during which the processing unit 104 computes the entropy of the co-occurrence matrix thus computed, in particular according to formula (1):

$$E = - {\sum }_{i , j} {P}_{θ}^{T} ( i , j ) \cdot log ( {P}_{θ}^{T} ( i , j ) )$$

where i and j are the indices of the co-occurrence matrix,
a contrast computing step 208 during which the processing unit 104 computes the contrast of the co-occurrence matrix thus computed, in particular according to formula (2):

$$C = {\sum }_{i , j} {( i - j )}^{2} {P}_{θ}^{T} ( i , j )$$

where i and j are the indices of the co-occurrence matrix,
a mean computing step 210 during which processing unit 104 computes the mean of the image just captured, in particular according to formula (3):

$$M = \frac{{\sum }_{k = 1}^{W} {\sum }_{l = 1}^{H} I ( k , l )}{W \cdot H} ,$$

where W is the width of the image, H is the height of the image, and I(k,l) is the grey level of the pixel of position (k,l),
a comparison step 212 during which the processing unit 104 compares the characteristics thus computed with reference values of these characteristics, and
a decision-taking step 214 during which the processing unit 104 takes a decision concerning the genuineness of the finger 50 from the result of the comparison step 212.

According to alternative embodiments, the checking method 200 comprises at least one of the following steps prior to the comparison step 212 and the comparison step then takes into account the results of these steps and compares the characteristics computed during these steps with reference values of these characteristics. The steps are:
a surface density computing step 211 during which the processing unit 104 performs, on the captured image, a segmentation of the peaks of the skin and pores and computes the surface density of the peaks of the skin and pores of the captured image,
a ratio computing step 213 during which the processing unit 104 computes the ratio between the degree of flattening (known as “kurtosis”) and the degree of asymmetry (referred to as “skewness”) of the distribution of grey levels of the captured image,
a step of computing the density of saturated pixels (215) in particular according to formula (9) explained below.

During the surface density computing step 211, the processing unit 104 performs, on the captured image, a segmentation of ridges (peaks of the skin) and closed pores (higher grey levels than the background pixels), for example by grey level histogram thresholding, and then a cleaning of the binary mask by applying a morphological opening (as described on the link https://en.wikipedia.org/wiki/Mathematical_morphology), and finally a computing of the surface density of the ridges and pores of the image thus processed and cleaned, in particular according to the formula:

$$d = \frac{{\sum }_{k = 1}^{W} {\sum }_{l = 1}^{H} ( S ( k , l ) )}{W \cdot H} , \qquad ( 6 )$$

where W is the width of the image, H is the height of the image and S(k,l) is the result of segmentation of the ridges and pores obtained after the cleaning by morphological opening.

The thresholding is done for example by means of a processing according to Otsu's method, which is described on the website http://en.wikipedia.org/wiki/Otsu's_method.

During the ratio computing step 213, the processing unit 104 computes the skewness, which is the degree of asymmetry of the distribution of grey levels of the captured image, and kurtosis, which is the degree of flattening of the distribution of grey levels of the captured image, and then the ratio between skewness (5) and kurtosis (4) of the image thus captured.

The kurtosis of the image thus captured is given in particular by the formula:

$$K = \frac{{\sum }_{k = 1}^{W} {\sum }_{l = 1}^{H} {( I ( k , l ) - M )}^{4}}{( W \cdot H - 1 ) \cdot {σ}^{4}} \qquad ( 4 )$$

where W is the width of the image, H is the height of the image, I(k,l) is the grey level of the pixel of position (k,l), α is the standard deviation of the image, that is to say the square root of the variance defined by the formula:

$$V = \frac{{\sum }_{k = 1}^{W} {\sum }_{l = 1}^{H} {( I ( k , l ) - M )}^{2}}{W . H - 1} ,$$

and M the mean of the image.

The skewness of the image thus captured is given in particular by the formula

$$S = \frac{{\sum }_{k = 1}^{W} {\sum }_{l = 21}^{H} {( I ( k , l ) - M )}^{3}}{( W . H - 1 ) . {σ}^{3}} \qquad ( 5 )$$

where W is the width of the image, H is the height of the image, I(k,l) is the grey level of the pixel of position (k,l), σ is the standard deviation of the image, that is to say the square root of the variance defined by the formula:

$$V = \frac{{\sum }_{k = 1}^{W} {\sum }_{l = 1}^{H} {( I ( k , l ) - M )}^{2}}{W . H - 1} ,$$

and M the mean of the image

A pixel is said to be saturated if its grey level is above a threshold which, according to a particular embodiment, is equal to 200, and the density of the saturated pixels is given by the formula:

$${d}^{sat} = \frac{{\sum }_{k = 1}^{W} {\sum }_{l = 1}^{H} 1 ( I ( k , l ) > threshold )}{W . H} , \qquad ( 9 )$$

where 1(I(k,l)>threshold)=1 if I(k,l)>threshold, et 1(I(k,l)>threshold)=0 is I(k,l)<t.

The ratio between skewness (5) and kurtosis (4) of the image thus captured is given in particular by the formula:

$$R = \frac{S}{K} = \frac{{\sum }_{k = 1}^{W} {\sum }_{l = 1}^{H} {( I ( k , l ) - M )}^{3} . σ}{{\sum }_{k = 1}^{W} {\sum }_{l = 1}^{H} {( I ( k , l ) - M )}^{4}} , \qquad ( 7 )$$

where W is the width of the image, H is the height of the image, I(k,l) is the grey level of the pixel of position (k,l), σ is the standard deviation of the image, that is to say the square root of the variance defined by the formula:

$$V = \frac{{\sum }_{k = 1}^{W} {\sum }_{l = 1}^{H} {( I ( k , l ) - M )}^{2}}{W . H - 1} ,$$

and M the mean of the image.

In order to limit the impact of the noise of the image on the results of the checks a Gaussian smoothing step is implemented by the processing unit 104 between the capture step 202 and the co-occurrence computing step 204.

According to a particular embodiment of the invention, the Gaussian smoothing is performed with a core of size 15×15 pixels and the standard deviation of the Gaussian is 3 in order to avoid breaking the cell structure that it is sought to characterise while attenuating the noise.

The Gaussian smoothing step consists of subjecting the captured image to a Gaussian smoothing.

The co-occurrence computing step 204, the entropy computing step 206, the contrast computing step 208, the mean computing step 210, the optional surface density computing step 211, the optional ratio computing step 213 and the optional step of computing the density of the saturated pixels are then performed on the image thus smoothed.

The system can be made robust to the movements of the finger 50. The capture step 202 then consists of:
capture of at least two full field OCT images of the finger or palm 50 by the capture device 102,
measurement of movement between said images with respect to each other,
readjustment of said images with respect to each other if the movement measurement detects a movement.
generation of a new image by computing the mean of said images.

This new image is then used in the remainder of the checking method 200 and is an image having less noise because the mean is effected on readjusted rather than offset images. The checking method 200 is then no longer impaired by a movement of the finger or palm 50.

The movement is measured by the processing unit 104, which compares the at least two full field OCT images successively acquired and determines whether any movement of the finger has taken place between these two images and, in the event of movement, the processing unit 104 can then readjust the images with respect to each other, or reject the check and recommence.

The latter feature cannot be achieved with a full field OCT system with a scanning system since movement of the finger will result in significant distortions of the final image.

For this purpose, the capture device 102 is designed to capture at least two full field OCT images, the processing unit 104 comprises means for measuring movement between said images with respect to each other, means for readjusting said images with respect to each other and means for generating a new image by computing the mean of said images.

The image captured at low depth (between 20 and 100 μm) by the capture device 102 constitutes an image where the whorls on the finger 50 appear. This image can be compared with reference images in a database, which ensures better robustness of the method since the image used for identification (whorls) is identical to the image used for checking frauds. This extraction can be done by a simple thresholding followed by a scaling of 500 dpi or 1000 dpi normal in the field of fingerprints. This is possible since the imaged field may be large in this full field OCT configuration.

The checking method 200 then comprises, subsequent to the capture step 202, a step of comparing the image of the whorls captured during the capture step 202 with reference images in a database and the decision-taking step 214 takes into account the result of this comparison step in order to decide on the authenticity of the finger 50 and the identity of the bearer of the finger 50.

The processing unit 104 then comprises second comparison means designed to compare the captured image with reference images in the database and the decision-taking means are designed to take a decision concerning the genuineness of the finger or palm 50 from the result supplied by the comparison means and concerning the identity of the bearer of the finger 50 from the results applied by the second comparison means.

To improve the results of the checks, the checking method 200 comprises, before the comparison step 212, a variance computing step during which the processing unit 104 computes the variance of the image thus captured or smother, in particular in accordance with the formula:

$$V = \frac{{\sum }_{k = 1}^{W} {\sum }_{l = 1}^{H} {( I ( k , l ) - M )}^{2}}{W . H - 1} \qquad ( 8 )$$

where W is the width of the image, H is the height of the image, I(k,l) is the grey level of the pixel of position (k,l), and M the mean of the image.

The comparison step 212 and the decision-taking step 214 will also then take into account this characteristic, the variance thus computed, in order to assess the genuineness of the finger 50.

The processing unit 104 comprises more particularly,
means for computing the co-occurrence matrix, designed to compute the co-occurrence matrix [P_{θ}^{T}(i,j)] of the captured image,
entropy computing means designed to compute the entropy of the co-occurrence matrix in accordance with the formula

$$E = - {Σ}_{i , j} {P}_{θ}^{T} ( i , j ) . log ( {P}_{θ}^{T} ( i , j ) ) \qquad ( 1 )$$

where i and j are the indices of the co-occurrence matrix,
contrast computing means designed to compute the contrast of the co-occurrence matrix in accordance with the formula

$$C = {{Σ}_{i , j} ( i - j )}^{2} {P}_{θ}^{T} ( i , j ) \qquad ( 2 )$$

where i and j are the indices of the co-occurrence matrix,
mean computing means designed to compute the mean of the captured imaged in accordance with the formula

$$M = \frac{{\sum }_{k = 1}^{W} {\sum }_{l = 1}^{H} I ( k , l )}{W . H} , \qquad ( 3 )$$

where W is the width of the image, H is the height of the image, and I(k,l) is the grey level of the pixel of position (k,l),
comparison means designed to compare the computed characteristics with reference values of these characteristics, and
decision-taking means designed to take a decision concerning the genuineness of the finger 50 from the results applied by the comparison means.

According to the checking method 200 used, the processing unit 104 also comprises:
surface density computing means designed to effect, on the captured image, a segmentation of the peaks of the skin and pores and to compute the surface density of the peaks of the skin and the pores of the captured image, and/or
ratio computing means designed to compute the ratio between the degree of flattening and the degree of asymmetry of the distribution of grey levels of the captured image, and/or
means for computing the density of the saturated pixels

The comparison means are then designed to take into account the characteristics computed by these means during comparisons with reference values of these characteristics.

The surface density computing means are for example designed to effect a segmentation of the peaks of the skin and pores by grey level histogram thresholding, and then a cleaning of the binary mask by applying a morphological opening, and the surface density computing means are designed to compute the surface density of the ridges and pores of the image thus processed and cleaned in accordance with the formula:

$$d = \frac{{\sum }_{k = 1}^{W} {\sum }_{l = 1}^{H} ( S ( k , l ) )}{W . H} . \qquad ( 6 )$$

The ratio computing means comprise kurtosis computing means designed to compute the kurtosis of the captured image in accordance with formula:

$$K = \frac{{\sum }_{k = 1}^{W} {\sum }_{l = 1}^{H} {( I ( k , l ) - M )}^{4}}{( W . H - 1 ) . {σ}^{4}} . \qquad ( 4 )$$

The ratio computing means comprise skewness computing means designed to compute the skewness of the captured image in accordance with the formula:

$$S = \frac{{\sum }_{k = 1}^{W} {\sum }_{l = 1}^{H} {( I ( k , l ) - M )}^{3}}{( W . H - 1 ) . {σ}^{3}} . \qquad ( 5 )$$

The ratio computing means comprise computing means designed to compute the ratio between the skewness and the kurtosis of the captured image in accordance with the formula:

$$R = \frac{S}{K} = \frac{{\sum }_{k = 1}^{W} {\sum }_{l = 1}^{H} {( I ( k , l ) - M )}^{3} . σ}{{\sum }_{k = 1}^{W} {\sum }_{l = 1}^{H} {( I ( k , l ) - M )}^{4}} . \qquad ( 7 )$$

When the checking method 200 comprises a Gaussian smoothing step, the processing unit 104 comprises Gaussian smoothing means designed to subject the captured image to a Gaussian smoothing, and the co-occurrence computing means, the entropy computing means, the contrast computing means, the mean computing means, the optional surface density computing means, the optional ratio computing means and the optional means for computing the density of the saturated pixels are designed to process the image smoothed by the Gaussian smoothing means.

When the checking method 200 comprises a variance computing step, the processing unit 104 comprises various computing means designed to compute the variance of the captured or smoothed image in accordance with the formula:

$$V = \frac{{\sum }_{k = 1}^{W} {\sum }_{l = 1}^{H} {( I ( k , l ) - M )}^{2}}{W . H - 1} . \qquad ( 8 )$$

Naturally the present invention is not limited to the examples and embodiments described and depicted but is capable of numerous variants accessible to persons skilled in the art.

1. Method for checking the authenticity of a finger or palm by means of a checking device comprising a full field optical coherence tomography capture device designed to capture at least one image of a plane parallel to the face of the finger or palm, and a processing unit, the method comprising:
a capture step during which the capture device captures a full field OCT image of the finger or palm,
a co-occurrence matrix computing step during which the processing unit computes the co-occurrence matrix of the image thus captured,
an entropy computing step during which the processing unit computes the entropy of the co-occurrence matrix thus computed,
a contrast computing step during which the processing unit computes the contrast of the co-occurrence matrix thus computed,
a mean computing step during which the processing unit computes the mean of the image thus captured,
a comparison step during which the processing unit compares the characteristics thus computed with reference values of these characteristics; and
a decision-taking step during which the processing unit takes a decision concerning the authenticity of the finger or palm from the result of the comparison step.

2. Checking method according to claim 1, wherein the method further comprises at least one of the following steps preceding the comparison and decision steps:
a surface density computing step during which the processing unit performs, on the captured image, a segmentation of the peaks of the skin and pores and computes the surface density of the peaks of the skin and pores of the captured image,
a ratio computing step during which the processing unit computes the ratio between the degree of flattening and the degree of asymmetry of the distribution of grey levels of the captured image, and
a step of computing the density of the saturated pixels.

3. Checking method according to claim 1, wherein the method comprises, between the capture step and the co-occurrence computing step, a Gaussian smoothing step implemented by the processing unit and during which the captured image is subjected to Gaussian smoothing, and in that the co-occurrence computing step, the entropy computing step, the contrast computing step, the mean computing step, the optional surface density computing step, the optional ratio computing step and the optional step of computing the density of the saturated pixels are performed on the image thus smoothed.

4. Checking method according to claim 1, wherein the method comprises a variance computing step during which the processing unit computes the variance of the image thus captured or smoothed.

5. Checking method according to claim 1, wherein the method comprises, subsequent to the capture step, a step of comparing the captured image with reference images in a database, and the decision-taking step takes into account the result of this comparison step in order to decide on the genuineness of the finger or palm and the identity of the bearer of the finger or palm.

6. Checking method according to claim 1, wherein the capture step consists of:
a capture of at least two full field OCT images of the finger or palm by the capture device,
a measurement of movement between said images with respect to each other,
a readjustment of said images with respect to each other if the movement measurement detects a movement, and
generation of a new image by computing the mean of said images.

7. Device for checking the genuineness of a finger or palm, the checking device being intended to implement the checking method according to claim 1 and comprising:
a transparent sheet on which the finger or palm comes to bear,
a capture device designed to capture a full field OCT image of a plane parallel to the face of the finger or palm through the transparent sheet,
a processing unit comprising:
co-occurrence matrix computing means designed to compute the co-occurrence matrix of the captured image,
entropy computing means designed to compute the entropy of the co-occurrence matrix,
contrast computing means designed to compute the contrast of the co-occurrence matrix,
mean computing means designed to compute the mean of the captured image,
comparison means designed to compare the computed characteristics with reference values of these characteristics, and
decision-taking means designed to take a decision concerning the authenticity of the finger or palm from the result supplied by the comparison means.

8. Checking device according to claim 7, wherein the processing unit further comprises:
surface density computing means designed to effect, on the captured image, a segmentation of the peaks of the skin and pores and to compute the surface density of the peaks of the skin and pores of the captured image, and/or
ratio computing means designed to compute the ratio between the degree of flattening and the degree of asymmetry of the distribution of grey levels of the captured image, and/or
means for computing the density of the saturated pixels.

9. Checking device according to claim 7, wherein the processing unit further comprises Gaussian smoothing means designed to subject the captured image to Gaussian smoothing, and in that the co-occurrence computing means, the entropy computing means, the contrast computing means, the mean computing means, the optional surface density computing means, the optional ratio computing means and the optional means for computing the density of the saturated pixels are designed to process the image smoothed by the Gaussian smoothing means.

10. Checking device according to claim 7, wherein the processing unit comprises various computing means designed to compute the variance of the captured or smoothed image.

11. Checking device according to claim 7, wherein the capture device is designed to capture at least two full field OCT images, in that the processing unit comprises means for measuring movement between said images with respect to each other, means for readjusting said images with respect to each other and means for generating a new image by computing the mean of said images.

12. Checking device according to claim 7, wherein the transverse resolution is from 0.8 to 5 microns.

13. Checking device according to claim 7, wherein the image capture depth is between 10 μm and 100 μm.

14. Checking device according to claim 13, wherein the processing unit then comprises second comparison means designed to compare the captured image with reference images in a database and in that the decision-taking means are designed to further take a decision concerning the identity of the bearer of the finger from the result supplied by the second comparison means.

15. Device according to claim 7, wherein the capture device comprises an oscillating mirror and a photodetector designed to acquire at least two images during the oscillation of the mirror, in that the processing unit comprises comparison means designed to compare said images with each other and to determine the existence of a movement of the finger or palm between each image, readjustment means designed to readjust the images with respect to each other and computing means designed to compute the component modulated by the movement of the mirror of said images.
